(19) United States
(12) Patent Application Publication
(10) Pub. No.: US 2024/0258787 A1
(43) Pub. Date: Aug. 1, 2024

(54) PROTECTION CIRCUIT, ELECTRICAL APPARATUS, CONTROL METHOD, DEVICE AND MEDIUM

(71) Applicant: Jiangsu Contemporary Amperex Technology Limited, Changzhou (CN)

(72) Inventors: Jinbiao Li, Changzhou (CN); Yu Yan, Changzhou (CN); Zhimin Dan, Changzhou (CN)

(73) Assignee: Jiangsu Contemporary Amperex Technology Limited, Changzhou (CN)

(21) Appl. No.: 18/636,313

(22) Filed: Apr. 16, 2024

Related U.S. Application Data
(63) Continuation of application No. 17/547,237, filed on Dec. 10, 2021.
Application No. 17/547,237 is a continuation of application No. PCT/CN2021/080075, filed on Mar. 10, 2021.

(51) Int. Cl. H02H 3/08

(52) U.S. Cl. CPC H02H 3/08

(57) ABSTRACT

A circuit control method is provided, in which a control module receives a target control instruction for pre-charging a target. The control module may be configured to select a main switch unit (Main-SU) and an auxiliary switch unit (Aux-SU) associated with the target, and control the Aux-SU to be in a continuous-on state. The control module may then control a semiconductor switch unit (Semi-SU) to be in an intermittent-on state to allow pre-charging of the target via the Semi-SU and the Aux-SU. After the target is pre-charged, the control module may control the Main-SU to be in an on-state, and control the Aux-SU and then the Semi-SU to be in an off-state.

### CROSS REFERENCE TO RELATED APPLICATION

The present application is a continuation of a U.S. patent application Ser. No. 17/547,237 filed on Dec. 10, 2021, which is a continuation of International Application No. PCT/CN2021/080075, filed on Mar. 10, 2021; the disclosures of above applications are hereby incorporated by reference herein in their entireties for all purposes.

### TECHNICAL FIELD

This application relates to the field of battery technology, and particularly to a protection circuit, high-voltage loop, electrical apparatus, control method, device and medium.

### BACKGROUND

With rapid development of battery technology, there is an increasing demand for battery control, especially for high-voltage and large-current batteries.

However, safety problems are often raised due to an impact of instantaneous large current, arcing and adhesion and so on, at a moment when a relay that is connected to a battery, such as a main positive relay and a charging positive relay etc., is turned on or off.

Therefore, there is a need for a technical solution that can improve the electrical safety of a high-voltage loop.

### SUMMARY

A circuit control method is provided, in which a control module receives a target control instruction for pre-charging a target. The control module may be configured to select a main switch unit (Main-SU) and an auxiliary switch unit (Aux-SU) associated with the target, and control the Aux-SU to be in a continuous-on state. The control module may then control a semiconductor switch unit (Semi-SU) to be in an intermittent-on state to allow pre-charging of the target via the Semi-SU and the Aux-SU. After the target is pre-charged, the control module may control the Main-SU to be in an on-state, and control the Aux-SU and then the Semi-SU to be in an off-state.

### BRIEF DESCRIPTION OF THE DRAWINGS

In order to illustrate technical solutions of embodiments of the present application more clearly, drawings necessary for the embodiments of the present application will be introduced briefly below. Obviously, the drawings described below are only some embodiments of the present application, and other drawings may be obtained from those drawings by those having ordinary skills in the art without any creative work.

FIG. 1 shows a schematic circuit diagram of a conventional battery high-voltage loop;

FIG. 2 shows a schematic structural diagram of a safety protection circuit provided by embodiments of the present disclosure;

FIG. 3 shows a schematic structural diagram of an exemplary battery high-voltage loop provided by embodiments of the present disclosure;

FIG. 4 shows a schematic structural diagram of another battery high-voltage loop provided by embodiments of the present disclosure;

FIG. 5 shows a schematic structural diagram of yet another battery high-voltage loop provided by embodiments of the present disclosure;

FIG. 6 shows a schematic structural diagram of an exemplary battery high-voltage loop provided by embodiments of the present disclosure;

FIG. 7 is a schematic flowchart of a circuit control method provided by embodiments of the present disclosure;

FIG. 8 is a schematic flowchart of another circuit control method provided by embodiments of the present disclosure; and

FIG. 9 illustrates a schematic structural diagram of hardware of a circuit control device, provided by embodiments of the present disclosure.

### DETAILED DESCRIPTION

Implementations of the present application are described in further details below with reference to the drawings and embodiments. The following detailed description of the embodiments and drawings are used to illustrate principles of the present application exemplarily, instead of limiting the scope of the present application. That is, the present application is not limited to the described embodiments.

In the description of the application, it should be noted that, unless otherwise stated, “a plurality of” means two or more; the terms “top”, “bottom”, “left”, “right”, “inside”, and “outside” used to indicate orientation or position relationships are only for purpose of facilitating the description of the application and simplifying the description, and do not indicate or imply that a device or element referred to must have a specific orientation, be constructed and operated in a specific orientation, and therefore cannot be understood as limitations to the application. In addition, the terms “first”, “second”, “third”, etc. are only used for descriptive purposes, and cannot be understood as indicating or implying relative importance. “Vertical” is not strictly vertical, but within an allowable range of error. “Parallel” is not strictly parallel, but within an allowable range of error.

The orientation words appearing in the following description are all directions shown in the figures, and do not limit the specific structure of the application. In the description of the application, it should also be noted that, unless otherwise explicitly stated and defined, the terms “installation”, “interconnection”, and “connection” should be understood in a broad sense, for example, it may be a fixed connection or a detachable connection, an integral connection; it may be a direct connection or an indirect connection through an intermediate medium. For those of ordinary skills in the art, specific meanings of the above-mentioned terms in this application may be understood according to specific circumstances.

It is to be noted that relational terms such as first and second are used herein simply to distinguish one entity or operation from another entity or operation without necessarily requiring or implying any actual such relationship or order between such entities or operations. Moreover, terms “comprising”, “including”, or any other variation thereof, are intended to cover non-exclusive inclusion, such that a process, method, article or device that include a series of elements may not include only those elements but may include other elements not explicitly listed or inherent to such process, method, article or device. Without more constraints, elements preceded by “include” do not preclude additional identical elements existing in the process, method, article or device that include the elements.

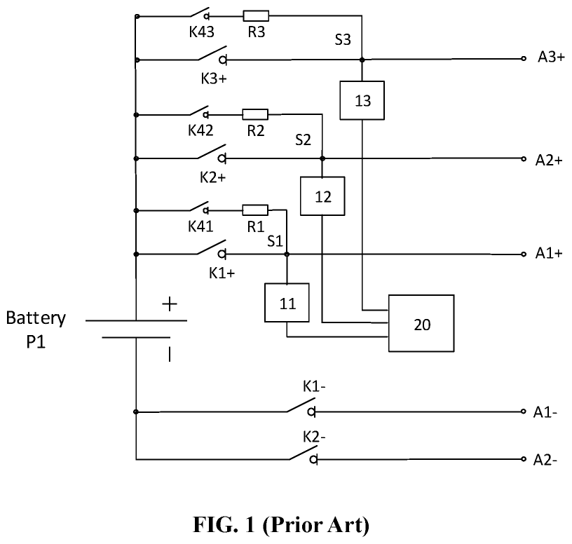

FIG. 1 shows a schematic circuit diagram of a conventional battery high-voltage loop. As shown in FIG. 1, a battery P1 is configured with a battery high-voltage loop, which is a high-voltage loop that forms a closed circuit with respect to the battery P1. The battery high-voltage loop may include a first positive switch unit K1+, a second positive switch unit K2+, and a third positive switch unit K3+. The first positive switch unit K1+, the second positive switch unit K2+, and the third positive switch unit K3+ may all be relays. Further, the positive switch units K1+, K2+ and K3+ may respectively be associated with a motor and high-voltage electrical device, e.g., air-conditioner, of a vehicle, via positive connecting ports A1+, A2+ and A3+.

The circuit in FIG. 1 may be configured with a first switch K41, a second switch K42, a third switch K43, a first resistor R1, a second resistor R2, and a third resistor R3. The first switch K41, the second switch K42, and the third switch K43 may all be relays. The first switch K41 and the first resistor R1 are series-connected, and then connected in parallel with the first positive switch unit K1+. That is, a first end of the first switch K41 is connected to a first end of the first positive switch unit K1+, a second end of the first switch K41 is connected to a first end of the first resistor R1, and a second end of the first resistor R1 is connected to a second end of the first positive switch unit K1+.

In some cases, in a similar fashion as the connection scheme of the first switch K41, the first resistor R1, and the first positive switch unit K1+ described above, the second switch K42 and the second resistor R2 are series-connected, and then connected in parallel with the second positive switch unit K2+; and the third switch K43 and the third resistor R3 are series-connected, and then connected in parallel with the third positive switch unit K3+.

In some cases, the circuit in FIG. 1 may also include a first sampling module 11 for collecting a voltage at a first sampling port S1, a second sampling module 12 for collecting a voltage at a second sampling port S2, and a third sampling module 13 for collecting a voltage at a third sampling port S3. The first sampling port S1 is arranged at the second end of the first positive switch unit K1+, the second sampling port P2 is arranged at the second end of the charging positive switch unit K2+, and the third sampling port P3 is arranged at the second end of the first electrical switch unit K3+.

Further, the circuit in FIG. 1 may also include a control module 20. The control module 20 determines whether to control the switch units K1+ to K3+ and the switches K41 to K43, according to the voltages sampled by the first sampling module 11, the second sampling module 12 and the third sampling module 13, i.e., according to the voltage of the second end S1 of the first positive switch unit K1+, the voltage of the second end S2 of the second positive switch unit K2+, and the voltage of the third end S3 of the third positive switch unit K3+.

However, the high-voltage loop and the process in the above cases may have the following technical issues: (1) there may be safety risks, such as arcing or adhesion of relay contacts, as well as loaded closing and loaded cutting-off, during high-voltage power-on and power-off of the first positive switch unit K1+, the second positive switch unit K2+, or the third positive switch unit K3+; (2) there may be structural redundancy and cost waste, since for each of the three positive switch units K1+, K2+, and K3+, another branch in parallel is required; (3) there may be structural redundancy and cost waste since multiple sampling modules and multiple sampling ports are set up; and (4) there may be low efficiency due to the low current, since the switch is continuously turned on during the process.

Embodiments of the present application provide a safety protection circuit, high-voltage loop, electrical apparatus, control method, device and medium. Those embodiments may be applied to application scenarios to improve the electrical safety of the battery high-voltage loop. Exemplarily, the application scenarios may include specific application scenarios when a main switch unit arranged on the power transmission circuit of the battery is turned on, turned off, or being pre-charged. The present disclosure can avoid safety risks, such as arcing or adhesion of relay contacts, and improve the electricity safety of the battery high-voltage loop.

Specific components, such as batteries, semiconductor switch units, mechanical switches, and high-voltage electrical devices, may be defined as the following:

(1) Batteries—the batteries may include lithium-ion batteries, lithium-metal batteries, lead-acid batteries, nickel-cadmium batteries, nickel-hydrogen batteries, lithium-sulfur batteries, lithium-air batteries, or sodium-ion batteries, which is not limited herein. In terms of scale, the batteries may be battery cells, or may be battery modules or battery packs, which is not limited herein. In terms of application scenarios, the batteries may be applied in power plants such as automobiles and ships. For example, the batteries may be applied in electric vehicles to act as power sources for the electric vehicles to supply power to motors of the electric vehicles. The batteries may also provide power for other electrical devices in the electric vehicles, such as in-vehicle air conditioners, vehicle-mounted players etc.

(2) Semiconductor switch units (or “Semi-SUs”)—the semiconductor switch units may refer to switches made of semiconductor. Exemplarily, the Semi-SUs may be implemented specifically as triodes, Metal-Oxide-Semiconductor Field-Effect Transistors (Metal-Oxide-Semiconductor Field-Effect Transistors, MOSFETs), and Insulated Gate Bipolar Transistors (Insulated Gate Bipolar Transistors, IGBT). Specific types of the Semi-SUs Q1 are not limited herein.

(3) Mechanical switches—the mechanical switches may be switches that change the on and off states using mechanical touches. In addition, the mechanical switches may also be used for electrical isolation. Exemplarily, the mechanical switches may be relays or other mechanical switches, which is not limited herein.

(4) High-voltage electrical devices—the high-voltage electrical devices refer to electrical devices which use high-voltage batteries as power sources. Exemplarily, for cars installed with batteries, the high-voltage electrical devices may include Direct Current-Direct Current (DCDC) converters, On-Board Controllers (OBCs), Power Distribution Units (PDUs), oil pumps, water pumps, Air conditioners (ACs), etc. that are installed in a vehicle.

Further, an “electrical apparatus” may refer to an apparatus that is equipped with a power battery. Thus, an electrical apparatus may be an electric vehicle or an electric ship, etc. A “power battery” may include the battery P1, a battery high-voltage loop. Based on the above concepts, the safety protection circuit, the battery high-voltage loop, and the electrical apparatus according to the embodiments of the present application may be described in details in conjunction with the accompanying drawings below. It should be noted that these embodiments are not used to limit the scope of the present disclosure.

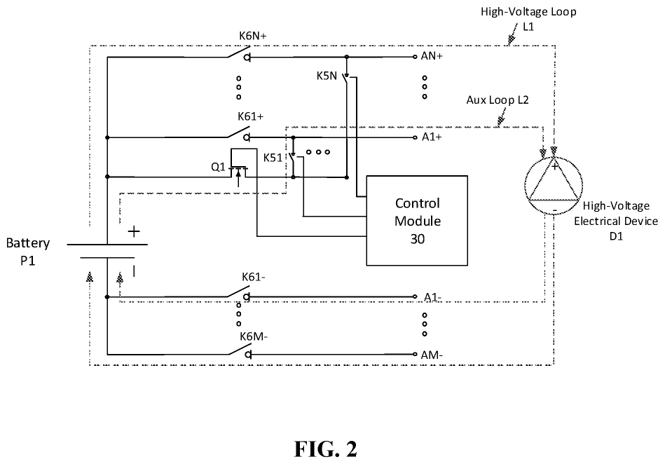

FIG. 2 shows a schematic structural diagram of a safety protection circuit provided by embodiments of the present disclosure. safety protection circuit refers to a battery high-voltage loop with safety protection. The battery P1 may have a positive electrode (marked by a “+” sign in FIG. 2) and a negative electrode (marked by a “−” sign in FIG. 2). The positive electrode and the positive electrode may also referred to as cathode and anode, respectively.

In some embodiments, the battery P1 may be connected to positive power transmission lines and the negative power transmission lines. Specifically, the “positive power transmission lines” may refer to one or more connections that connect the positive electrode of the battery P1 with the positive connecting ports A1+ to AN+(also referred to as positive high-voltage ports, or positive connecting ports) via various wirings and switch units. Thus, the positive power transmission lines may be viewed as electric transmitting paths that enable electric current to flow between the positive electrode of the battery P1 and the positive connecting ports A1+ to AN+. Likewise, the “negative power transmission lines”, which connect the negative electrode of the battery P1 with the negative connecting ports A1− to AM− (also referred to as negative high-voltage ports) via various wirings and switch units, may be deemed electric transmitting paths that allow electric current to flow between the negative electrode of the battery P1 and the negative connecting ports A1− to AM−.

In some embodiments, the positive power transmission lines may be configured with positive switch units K61+ to K6N+, which may also be referred to as positive switch units. And the negative power transmission lines may be configured with negative switch units K61− to K6M− (also referred to as negative switch units). M and N may be any positive integers, for example, M and/or N may be greater than or equal to 2, and M and N may or may not be equal to each other. For convenience purposes, there may be N positive transmission lines and N negative transmission lines in some of the following detailed description.

In some embodiments, each of the positive connecting ports A1+ to AN+ may be connected with a positive terminal of a corresponding external device, and each of the negative connecting ports A1− to AM− may be connected with a negative terminal of a corresponding external device. The positive connecting ports and the negative connecting ports may support hot-pluggable external devices, such as when an external refrigerator or heater is dynamically hot-plugged into these connection ports.

In some embodiments, the first positive switch unit K61+ is arranged between the positive electrode of the battery P1 and a motor. Specifically, a first end of the first positive switch unit K61+ may be connected to the positive electrode of the battery P1, and a second end of the first positive switch unit K61+ may be connected to the positive connecting port A1+, which is connected to a positive terminal of the motor. A negative terminal of the motor is connected to the negative electrode of the battery P1 through a negative connecting port A1− and a first negative switch unit K61−, sequentially.

In some embodiments, the second positive switch unit (charging positive switch unit) K62+ is arranged between the positive electrode of the battery P1 and an external charging apparatus (e.g., a charging station). Specifically, a first end of the second positive switch unit K62+ may be connected to the positive electrode of the battery P1, and a second end of the second positive switch unit K62+ may be connected to a positive connecting port A2+, which is connected to a positive terminal of the external charging apparatus. A negative terminal of the external charging apparatus is connected to the negative electrode of the battery P1 through a negative connecting port A2− and a second negative switch unit K62−, sequentially.

In some embodiments, the external charging apparatus (e.g., a charging pole or a vehicle-mounted charger) may be configured to charge the battery P1. During charging, the high-voltage current may be transmitted from the positive connecting port A2+ to the positive electrode of the battery P1 through the second positive switch unit K62+. Thus, a direction of the electric current during charging (“charging direction”) may be opposite/reverse to a direction of the electric current during discharging (“discharging direction”), which may be from the battery P1 to the positive connecting port A1+ for operating a motor.

In some embodiments, the third positive switch unit (namely electrical positive switch unit) K63+ may be arranged between the positive electrode of the battery P1 and a high-voltage electrical device (e.g., an air conditioner). Specifically, a first end of the third positive switch unit K63+ is connected to the positive electrode of the battery P1, and a second end of the third positive switch unit K63+ is connected to a positive connecting port A3+, which is regarded as a high-voltage output port herein. The positive connecting port A3+ is configured to connect to a positive terminal of the high-voltage electrical device. A negative terminal of the high-voltage electrical device is connected to the negative electrode of the battery P1 through a negative connecting port A3− and a third negative switch unit K63−, sequentially.

In some embodiments, the positive power transmission lines of the battery P1 are configured with N positive switch units K61+ to K6N+, and the negative power transmission lines of the battery P1 may not be configured with any negative switch units. Alternatively, the positive power transmission lines of the battery P1 may not be configured with any positive switch units, and the M negative power transmission lines of the battery P1 are configured with negative switch units K61− to K6M−.

In some embodiments, the positive power transmission lines of the battery P1 may be configured to transmit high-voltage power between the battery P1 and the motor, charging apparatus, and high-voltage electrical devices. In this case, the motor, the charging apparatus, or the high-voltage electrical devices may be connected with a corresponding positive power transmission line and a corresponding negative power transmission line. If each positive power transmission line is configured with a corresponding positive switch unit, then the N positive switch units may have one-to-one associations with the N number of motor, charging apparatus, and high-voltage electrical devices. Likewise, if each negative power transmission line may be configured with a corresponding negative switch unit, then the M negative switch units may have one-to-one associations with the M number of motor, charging apparatus, and the high-voltage electrical devices.

In some embodiments, the positive power transmission lines of the battery P1 may be configured with the positive switch units, and the positive switch units may be deemed positive main switch units (positive Main-SUs). For example, as shown in FIG. 2, the positive Main-SUs may be the N positive switch units K61+ to K6N+. Likewise, the negative power transmission lines of the battery P1 may be configured with negative switch units, and the negative switch units may be deemed negative main switch units (negative Main-SUs). For example, as shown in FIG. 2, the negative Main-SUs may be the M negative switch units K61− to K6M−.

In some embodiments, the positive power transmission lines and the negative power transmission lines of the battery P1 may be configured with positive Main-SUs and negative Main-SUs respectively. In this case, the Main-SUs may include the positive switch units K61+ to K6N+ and/or the negative switch units K61− to K6M−. Whether the Main-SUs are referring to the positive switch units K61+ to K6N+ and/or the negative switch units K61− to K6M− may be determined by functions of the high-voltage electrical devices. In an example, if the high-voltage electrical device is powered by a power source other than the battery P1, the Main-SUs may include the first positive switch unit K61+ and the second positive switch unit (namely charging positive switch unit) K62+. In another example, if the electrical apparatus has the charging function and the high-voltage electrical device can be powered by the battery P1, the Main-SUs may include the first positive switch unit K61+, the second positive switch unit K62+, and the third positive switch unit (namely electrical positive switch unit) K63+. It should be noted that, depending on different functions of the electric devices, the Main-SUs may also have other combinations, which are not specifically limited in the embodiment of the present application.

As shown in FIG. 2, the safety protection circuit further includes N auxiliary switch units (Aux-SUs) K51 to K5N, a semiconductor switch unit (Semi-SU) Q1, and a control module 30. Specifically, the N Aux-SUs K51 to K5N may have a one-to-one correspondence/connection with the N Main-SUs K61+ to K6N+. That is, the Aux-SU K51 corresponds and connects to the Main-SU K61+, the Aux-SU K52 corresponds and connects to the Main-SU K62+, . . . and the Aux-SU K5N corresponds and connects to the Main-SU K6N+.

In some embodiment, the N Aux-SUs K51 to K5N may be mechanical switches. Selecting mechanical switches as the Aux-SUs K51 to K5N may have the following advantages compared with selecting semiconductor switches: (1) the conduction loss can be reduced; (2) a risk of thermal runaway caused by heating of the semiconductor switches can be decreased; (3) a risk of thermal failure can be reduced and cost can be reduced since there is no need to install a cooling structure additionally; (4) electrical isolation of the safety protection circuit can be achieved using electrical characteristics of the mechanical switches, so that the safety protection circuit may satisfy the isolation standard of vehicle regulation level.

In some embodiments, for each one of the Main-SUs K61+ to K6N+, the Semi-SU Q1 is connected in parallel with this Main-SU through an Aux-SU corresponding to this Main-SU. Exemplarily, as shown in FIG. 2, a first end of the Semi-SU Q1 and a first end of the Main-SU K61+ are connected to the positive electrode of the battery P1; a second end of the Semi-SU Q1 is connected to a first end of the Aux-SU K51; and a second end of the Aux-SU K51 is connected to the second end of the Main SU K61+. The Semi-SU Q1 is similarly connected with all the Main-SUs K62+ to K6N+ via the corresponding Aux-SUs K52-K5N. In other words, the second end of the Semi-SU Q1 is connected to the second ends of the Main-SUs K62+ to K6N+ through the Aux-SUs K52 to K5N, respectively.

In some embodiments, the control module 30 may be configured to control the Semi-SU Q1, the Main-SUs K61+ to K6N+, and/or the Aux-SUs K51 to K5N. For example, the control module 30 may be configured to control the Semi-SU Q1 and at least one of the Aux-SUs K51 to K5N prior to control one of the Main-SUs K61+ to K6N+. In some embodiments, the control module 30 may be implemented as a Micro Control Unit (MCU). The control module 30 may also be implemented as a high-voltage Power Distribution Unit (PDU).

In some embodiments, high-voltage current that is transmitted between the battery P1 and a positive connecting port (e.g., A1+) may either pass through a Main-SU (e.g., K61+), or alternatively pass through the Semi-SU Q1 and an Aux-SU (e.g., K51) corresponding to the Main-SU. Based on different modes of operations, the control module 30 may be configured to control which route the high-voltage current should be configured to pass through, as well as the order of switching on/off the various switch units (e.g., Main-SUs, Aux-SUs, and/or Semi-SU) based on specific instructions.

In some embodiments, the control module 30 may be configured to control the various switch units to form a high-voltage loop. For example, as shown by a dotted line in FIG. 2, a high-voltage loop L1 may be a closed circuit starting from the positive electrode of the battery P1, passing through a first positive transmission line with the Main-SU K6N+, reaching the positive terminal of an external high-voltage electrical device D1 via the positive connecting port AN+, passing through a first negative transmission line via the negative terminal of the high-voltage electrical device D1 and the negative connecting port AM−, and reaching the negative electrode of the battery P1.

In some embodiments, the control module 30 may be configured to control the various switch units to form an auxiliary loop. For example, as shown by another dotted line in FIG. 2, an auxiliary loop L2 may be a closed circuit starting from the positive electrode of the battery P1, passing through a second positive transmission line with the Semi-SU Q1 and the Aux-SU K51, reaching the positive terminal of the external high-voltage electrical device D1 via the positive connecting port A1+, passing through a second negative transmission line via the negative terminal of the high-voltage electrical device D1 and the negative connecting port A1−, and reaching the negative electrode of the battery P1. Thus, the control module 30 may be configured to control the high-voltage current to form a high-voltage loop or an auxiliary loop, by controlling the order of switching on/off the various switch units.

It should be noted that FIG. 2 only shows a case where the Main-SUs are positive Main-SUs. In this case, the Semi-SU Q1+ may be connected in parallel with each of the N positive Main-SUs through a respective one of N Aux-SUs K51-K5N. Alternatively, the Main-SUs may only include negative Main-SUs. In this case, a Semi-SU Q1− may be connected in parallel with each of the M negative Main-SUs through a respective one of the M Aux-SUs. In addition, if the Main-SUs include both the positive Main-SUs and the negative Main-SUs, the number of Semi-SUs may be two, and a first Semi-SU Q1+ may be connected in parallel with each of the positive Main-SUs through a respective one of the Aux-SUs, and a second Semi-SU Q1− may be connected in parallel with each of the negative Main-SUs through a respective one of the Aux-SUs.

In some embodiments, a single Semi-SU Q1 may be configured to coordinate with one or more of the Aux-SUs when being switched on or off. In other words, this single Semi-SU Q1 may simultaneously works with one, more, or all of the Aux-SUs K52-K5N. For example, the Semi-SU Q1 may work with K51 and K53 to pre-charge a motor and an air-conditioner at the same time. Alternatively, the Semi-SU Q1 may perform switch operations when multiple electric devices are being turned on or off. Additional details are provided below.

In some embodiments, the control module 30 may be configured to receive a target control instruction, and perform a specific operation (i.e., enter a target stage) in response to the target control instruction. The target stage may include a pre-charging stage corresponding to a target main switch unit (target Main-SU), and/or a switching stage during which an on-off state of the target Main-SU is switched. For example, as shown in FIG. 2, the target Main-SU(s) may be one or more of the Main-SUs K61+ to K6N+. In each target stage, the control module 30 may perform specific operations by controlling the target Main-SU, an Aux-SU corresponding to the target Main-SU, and/or the Semi-SU. Further, the control module 30 may include multiple control units, each of which may be configured to control a corresponding one of the Main-SUs, Aux-SUs, and Semi-SU.

In some embodiments, the control module 30 may control each of the various switch units describe above to be in, without limiting, an on-state, an off-state, a continuous-on state, or an intermittent-on state. In an on-state, the specific switch unit may be “closed”, “on”, or “connected”, so that electric current may pass through. In an off-state, the specific switch unit may be “opened”, “off”, or “disconnected”, so that no electric current may pass through.

Specifically, the control module 30 may transmit a single turn-on signal to a particular switch unit to be in the on-state, or transmit a single turn-off signal to the particular switch unit to be in the off-state. Further, the control module 30 may transmit multiple turn-on signals in intervals to the particular switch unit to be in the continuous-on state, so that even if the particular switch unit cannot maintain on-state for a long time, or other modules may transmit turn-off signals to this particular switch unit during the meantime, this particular switch unit may nevertheless be turned back on by the subsequent multiple turn-on signals.

In some embodiments, the control module 30 may transmit multiple (more than 2 sets of) alternating turn-on and turn-off signals in intervals to the particular switch unit to be in the intermittent-on state, so that the particular switch unit may be repeatedly in alternating on-state for a period of time and off-state for another period of time. Specifically, when the switch unit receives the turn-off signal, no current may pass through the switch unit until the switch unit receives a subsequent turn-on signal. When the switch unit receives the turn-on signal, current may pass through the switch unit without substantial energy or voltage loss, until a subsequent turn-off signal which may cause the switch unit to completely turned off. Thus, the electricity passing through an intermittent-on switch unit may have a voltage or current change ranging from zero to full amount. Further, the turn-on and turn-off signals may have a steady frequency or a high-to-low (or low-to-high) frequency change. For example, the high-to-low frequency change allows the switch unit to have a faster switching on/off rate in the beginning, and then gradually reduce to a slower switching on/off rate.

In some embodiments, the target control instruction received by the control module 30 may include, without limiting, “pre-charging” instructions, “switching” instructions, “power-on” instructions, and “power-off” instructions. Pre-charging instructions may include, without limiting, pre-charging one or more specific targets (i.e. target electrical devices). Switching instructions may include, without limiting, switching-on one or more specific targets, switching-off one or more specific targets, start-charging by an external charging apparatus, and stop-charging by the external charging apparatus. Power-on instructions may include power-on the entire electrical apparatus or power-on one or more specific targets. And power-off instruction may include power-off the entire electrical apparatus or power-off one or more specific targets. A target (or an electrical target, or a target device) may be a motor, an external charging apparatus, or a specific high-voltage electrical device that is connected with the battery P1 via the battery high-voltage loop.

In some embodiments, for a target Main-SU (e.g., a Main-SU that is associated with a target), a pre-charging instruction may instruct the control module 30 to enter into a “pre-charge stage”, in order to allow a capacitor located in the target to be pre-charged. Likewise, before switching on or switching off a target Main-SU associated with a target, a switching instruction may instruct the control module 30 to enter into a “switching stage”.

In some embodiments, in response to a pre-charging instruction for a specific target, the control module 30 may be configured to perform a sequence of controls on the target Main-SU, the Aux-SU associated with the target Main-SU and the Semi-SU. Specifically, in the pre-charging stage, the control module 30 may be configured to control the Aux-SU corresponding to the target Main-SU to be in the continuous-on state and control the Semi-SU Q1 to be in the intermittent-on state. After the target is pre-charged, the control module 30 may be configured to perform another sequence of controls on the target Main-SU, the Aux-SU associated with the target Main-SU and the Semi-SU. In other words, in the pre-charging stage, the control module 30 may control the switch units to form an auxiliary loop, thereby allowing electric current from the battery P1 to pre-charge the target via the auxiliary loop.

For example, for a pre-charging instruction related to the pre-charging of a capacitor of the motor, the target Main-SU may be a positive Main-SU K61+, which corresponds to the Aux-SU K51. The control module 30 may then control the Aux-SU K51 to be in the continuous-on state, and control the Semi-SU Q1 to be in the intermittent-on state. Likewise, during the process of pre-charging a high-voltage electrical device, the target Main-SU may be the positive Main-SU K63+, which corresponds to the Aux-SU K53. The control module 30 may control the Aux-SU K53 to be in the continuous-on state, and control the Semi-SU Q1 to be in the intermittent-on state. It should be noted that specific implementations in which the target Main-SU includes the first negative switch unit, the second negative switch unit (i.e., the negative charging switch unit), or any other positive or negative switch unit are similar as those described above.

In some embodiments, the control module 30 may cause the Semi-SU Q1 to be in the intermittent on-off state by sending a pulse signal to a control terminal of the Semi-SU Q1. For example, the pulse signal may be a Pulse Width Modulation (PWM) signal. For example, the control module 30 may calculate a period and duty ratio of the PWM signal required for charging a load capacitor to 95% or more of a power supply voltage within a required pre-charging time according to parameters of the capacitor and the pre-charging time requirements. The PWM signal with the particular period and duty ratio may then be output by a PWM control unit, when a circuit current keeps in a safe range. The PWM signal may be output to the control terminal of the Semi-SU Q1, such as a gate of the semi-SU Q1. In addition, the PWM signal may also be transmitted to the MCU synchronously.

In some embodiments, the target control instruction received by the control module 30 for pre-charging may be sent by a Battery Management System (BMS). For example, the electrical apparatus may be an electric vehicle, and the control module 30 may receive a power-on request instruction from the electric vehicle. In this case, the control module 30 may enter the process of pre-charging a capacitor of the motor. In another example, in response to a power-on request instruction for the high-voltage electric device, the control module 30 may enter the process of pre-charging the capacitor of the high-voltage electric device.

In some embodiments, the control module 30 may be configured to control the Semi-SU Q1 to be in the intermittent-on state, after a preset time period once the corresponding Aux-SU is closed (turned-on). Specifically, in order to prevent an arcing risk, the control module 30 may turn-on the Semi-SU Q1 after the Aux-SU is turned on for the preset time period. In this case, the preset time period is greater than or equal to a time period required by the Aux-SU to go from the off-state to the on-state. For example, the preset time period may be 20 milliseconds (ms). It should be noted that the preset time period can also be set according to specific scenarios and actual needs, which is not limited specifically.

In some embodiments, when the Semi-SU Q1 is controlled to be turned on intermittently, a pre-charging rate (i.e., a frequency of intermittently turning-on and turning-off) can be flexibly adjusted since the pre-charging current can be controlled according to parameters such as a conduction frequency and a duty ratio of the control signal. Thus, the flexibility of the overall pre-charging process can be further optimized by adjusting the pre-charging rate. In addition, the electricity safety of the pre-charging process can be improved, since there is no arcing or adhesion risk for the Semi-SU.

In some embodiments, in order to further improve safety, once the pre-charging stage is completed, the control module 30 may be configured to control the target Main-SU to be in the on-state (being turned-on), and then control the Aux-SU corresponding to the target Main-SU and the Semi-SU to be in the off-state (being turned-off) sequentially. Specifically, the control module 320 may determine whether to finish the pre-charging stage based on whether a voltage value of the second end of the target Main-SU sampled by a sampling module is substantially equal to a voltage value of the battery. In order to improve the accuracy of the above determination, the control module 30 may determine whether to stop the pre-charging process according to whether the voltage value of the second end of the target Main-SU is substantially equal to the voltage value of the battery and whether a current value in the auxiliary loop (namely pre-charging loop) is close to zero. It should be noted that the first end of the target Main-SU (which is opposite to the second end of the target Main-SU) is connected to the positive electrode of the battery. Once the pre-charging stage is completed, the control module 30 may control the switch units to open the auxiliary loop and start the high-voltage loop, thereby allowing electric current from the battery P1 to power the target via the high-voltage loop.

In some embodiments, the control module 30 may be configured to, in response to a switch control instruction, perform a switch operation, during which the on-off state of the target Main-SU is switched. Switching the on-off state of the target Main-SU may refer to the switching the target Main-SU from an off-state to an on-state, or the switching the target Main-SU from the on-state to the off-state. During this switching stage, the control module 30 may be configured to control both the Aux-SU corresponding to the target Main-SU and the Semi-SU Q1 to be in the continuous-on state, before the on-off state of the target Main-SU is switched. Particularly, before the target Main-SU is turned on or off, the control module 30 may turn on the Aux-SU corresponding to the target Main-SU and the Semi-SU Q1.

In some embodiments, especially when the Aux-SUs are mechanical switches, in order to prevent arcing or adhesion phenomena, the Aux-SUs may be firstly controlled to be turned on, and the Semi-SU Q1 may be subsequently controlled to be turned on. Specifically, the control module 30 may first turn on the Aux-SU K5i (“i” being any positive integer less than or equal to N), and after a preset time period, then turn on the Semi-SU. After the Aux-SU and the Semi-SU are controlled to enter the continuous-on state, the control module may then control the target Main-SU to switch from the off-state to the on-state (or switch from the on-state to the off-state). Once the on-off state of the target Main-SU is switched, the Semi-SU Q1 and the auxiliary switch unit may be controlled to be turned off simultaneously or sequentially.

In other words, before switching the target Main-SU, the control module 30 may control the various switch units to start the auxiliary loop, thereby allowing electric current from the battery P1 to be transmitted to the target via the auxiliary loop. After the target-Main-SU is switched, the control module 30 may control the switch units to open the auxiliary loop. Thus, by turning-on the Aux-SU and the Semi-SU before the on-off state of the Main-SU is switched, safety risks such as arcing, which is caused during the switching on/off of the Main-SU, can be greatly prevented. Further, the above safety protection circuit may further avoid safety risks such as adhesion of relay contacts and improve the electricity safety of the battery high-voltage loop, when the Semi-SU, the Main-SUs, and the Aux-SUs are controlled in various orders during the pre-charging stage and/or the switching stage.

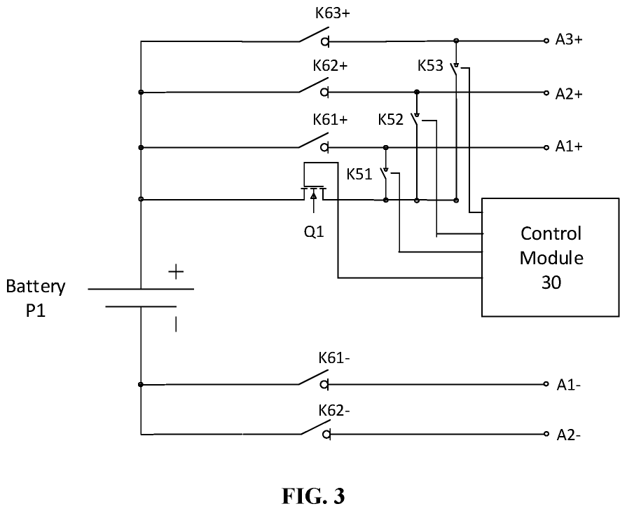

In addition, since only one Semi-SU is needed to control multiple Main-SUs and Aux-SUs, multiplexing of the Semi-SU can be realized, so as to save costs and simplify the circuit structure. For ease of understanding, an example in which the main switch units include the first positive switch unit, the second positive switch unit (namely charging positive switch unit), and the third positive switch unit (namely electrical positive switch unit) is described in the following embodiments of the present application in conjunction with FIG. 3, to illustrate the specific connection structure of the safety protection circuit in details.

FIG. 3 is a schematic structural diagram of an exemplary safety protection circuit provided by embodiments of the present disclosure. As shown in FIG. 3, the safety protection circuit may include, without limiting, the Main-SUs K61+, K62+, and K63+, the Aux-SUs K51, K52, and K53, and the Semi-SU Q1. As an example, the K61+ may be associated with a motor, the K62+ may be associated with a charging apparatus, and K63+ may be associated with an electrical device. Other Main-SUs and Aux-SUs that are not shown in FIG. 3 may be associated with additional electrical devices.

As shown in FIG. 3, a first end of the Semi-SU Q1, a first end of the Main-SU K61+, a first end of the Main-SU K62+, and a first end of the Main-SU K63+ are all connected to the positive electrode of the battery P1. And a second end of the Semi-SU Q1 is connected to a second end of the Main-SU K61+ through the Aux-SU K51, to a second end of the Main-SU K62+ through the Aux-SU K52, and to a second end of the Main-SU K63+ through the Aux-SU K53.

In some embodiments, the control module 30 may be configured to receive a high-voltage power-on request instruction from the electrical apparatus, requesting a pre-charging operation for a specific target device (e.g., motor or electric device, etc.). After a preset time period (greater than reaction time required for the relay to close, for example, 20 ms), the control module 30 may identify the specific Main-SU (e.g., one of Main-SUs K61+ to K63+) associated with the target device, and determine the specific Aux-SU (e.g., one of Aux-SUs K51 to K53) corresponding to the specific Main-SU. The control module 30 may then control the specific Aux-SU to be turned on, and subsequently control the Semi-SU Q1 to be intermittently turned on to pre-charge the target device (or the target device's capacitor).

Once the pre-charging of the target device is determined to be completed, the control module 30 may be configured to control the specific Main-SU to be turned on, while the Semi-SU Q1 and the specific Aux-SU remain in the on-state. After another preset time period once the Main-SU is turned on, the control module 30 may be configured to control the Aux-SU to be turned off and control the Semi-SU Q1 to be turned off after a further preset time period, in order to reduce/avoid energy losses from the Semi-SU Q1 and reduce the heating phenomenon of the Semi-SU Q1. Therefore, no additional thermal design is needed and the energy cost can be reduced.

It should be noted that, if the main switch units include the negative switch units, the control module 30 may perform operations after receiving the power-on request instruction of the electrical device that are similar as those of the positive switch units.

In some embodiments, the control module 30 may further be configured to diagnose the state of the Semi-SU Q1 before the Main-SU is turned on. Particularly, if the Semi-SU Q1 is diagnosed to be in the on-state, the control module 30 may determine that the Semi-SU Q1 is in a normal state, and the Main-SU can be controlled to be turned on normally. And if the Semi-SU Q1 is diagnosed to be in the off-state, a fault should be reported, and the entire vehicle should be powered off. The above configuration may ensure that the Main-SU will not face an abnormal operating condition of loaded closing, such that the risks such as arcing of the Main-SU can be further avoided and thereby the electricity safety can be further improved.

In some embodiments, the control module 30 may also control high-voltage components of the electrical apparatus to discharge in response to a power-off request instruction of the electrical apparatus. The control module 30 may be configured to receive a high-voltage power-off request instruction from the electrical apparatus, requesting power-off a specific target (e.g., motor, charging apparatus, electric device, etc.). After a preset time period, the control module 30 may identify the specific Main-SU (e.g., one of Main-SUs K61+ to K63+) associated with the target, and determine the specific Aux-SU (e.g., one of Aux-SUs K51 to K53) corresponding to the specific Main-SU. The control module 30 may then control the specific Aux-SU to be turned on, and after a preset time period has elapsed, control the Semi-SU Q1 to be turned on. After another preset time period has elapsed, the control module 30 may control the Main-SU to be turned off.

In some embodiments, after the positive Main-SU (e.g. K61+) is turned off based on the above sequence of operations, the control module 30 may be configured to control the negative Main-SU (e.g., K61−) to be turned off after the Aux-SU (e.g., K51−) and Semi-SU Q1− are sequentially turned off for a preset time period. Alternatively, an emergency power-off procedure may include controlling the negative Main-SU K61− to be turned off first, and then controlling the positive Main-SU K61+ to be turned off. The above configuration can ensure that the positive Main-SU K61+ will not face an abnormal operating condition of loaded cutting-off, such that the risks such as arcing of the positive Main-SU K61+ can be further avoided and thereby the electricity safety can be further improved.

In some embodiments, the control module 30 may be configured to receive a charging request instruction from the electrical apparatus, requesting to charge the battery P1 from an external charging apparatus. The control module 30 may identify the specific Main-SU (e.g., K62+) associated with the external charging apparatus, and determine the specific Aux-SU (e.g., K52) corresponding to the Main-SU K62+. The control module 30 may then control the Aux-SU K52 to be continuously turned on, and subsequently control the Semi-SU Q1 to be continuously turned on. Afterward, the control module 30 may be configured to control the Main-SU K62+ to be turned on, while the Semi-SU Q1 and the specific Aux-SU K52 remain in the on-state. After another preset time period once the Main-SU K62+ is turned on, the control module 30 may be configured to control the Aux-SU K52 and the Semi-SU Q1 to be turned off sequentially. The external charging apparatus may then transmit charging current from the external charging apparatus to the battery P1 via the Main-SU K62+, the charging current having a current direction that is opposite to the discharging direction from the battery P1 to the motor or to an electric device.

In some embodiments, the control module 30 may control the Main-SU K62+ to be turned off safely after the battery is fully charged. Specifically, the control module 30 may be configured to control the Aux-SU K52 to be turned on after receiving a stop-charging request instruction, and control the Semi-SU Q1 to be turned on after the Aux-SU K52 is turned on and a preset time period has elapsed. Further, the control module 30 may be configured to control the Main-SU K62+ to be turned off after the Semi-SU Q1 is turned on. Afterward, the control module 30 may be configured to control the Semi-SU Q1 and the Aux-SU K52 to be turned off sequentially after the Main-SU K62+ is turned off and a preset time period has elapsed.

In some embodiments, if the main Main-SUs include negative switch units, the control module 30 may perform switch operations that are similar as those of the positive switch units. Specifically, the control module 30 may be configured to control the negative Main-SU K62− to be turned off after the Aux-SU K52− and the Semi-SU Q1− are sequentially turned off and a preset time period has elapsed. In a particular emergency power-off procedure, the control module 30 may control the negative Main-SU K62− to be turned off at first, and then control the positive Main-SU K62+ to be turned off. The above procedure can ensure that the positive Main-SU K62+ will not face an abnormal operating condition of loaded cutting-off, such that the risk such as arcing of the positive Main-SU K62+ can be further avoided and thereby the electricity safety can be further improved.

In some embodiments, the control module 30 may be configured to receive a high-voltage power-on request instruction from the electrical apparatus, requesting the performing of pre-charging operations for multiple targets (e.g., motor, and one or more electric devices, etc.). For example, the multiple targets may be multiple high-voltage electrical devices including air-conditioner and head-lamp, etc. The control module 30 may identify these Main-SUs (e.g., K63+, K64+, etc.) that are associated with the multiple targets, and determine the specific Aux-SUs (e.g., K53, K54, etc.) corresponding to these Main-SUs. The control module 30 may then control the specific Aux-SUs to be turned on either one-by-one sequentially, simultaneously, or in random order. Once all the Aux-SUs are turned-on, the control module 30 may then control the Semi-SU Q1 to be intermittently turned on to pre-charge the multiple targets.

In some embodiments, the control module 30 may be configured to receive multiple high-voltage power-on request instructions from the electrical apparatus in a short period, each of the instructions requesting the performing of pre-charging operation for a particular target. In this case, the control module 30 may either process the multiple instructions one-by-one, meaning that the control module 30 may complete the processing of one instruction before processing the next instruction, or process these instructions together as a single instruction requesting for pre-charging of multiple targets, as described above.

In some embodiments, the control module 30 may identify the Main-SUs and Aux-SUs associated with the multiple targets corresponding to these multiple instructions, and then control each of the specific Aux-SUs to be turned on. Specifically, before turning on a specific Aux-SU, the control module 30 may evaluate whether the Semi-SU Q1 has already been turned on or not. If the Semi-SU Q1 is determined to be turned on before the Aux-SU, it may indicate that the Semi-SU Q1 may already be in a pre-charging stage or switching stage that involves other Main-SUs or Aux-SUs. In this case, the control module 30 may periodically evaluate the Semi-SU Q1, until it is determined that the Semi-SU Q1 is turned-off, and the control module 30 may then turn on the specific Aux-SU. The control module 30 may await until all of these Aux-SUs are turned-on, and then control the Semi-SU Q1 to be intermittently turned on to pre-charge the targets. After the pre-charging of the targets are complete, the control module 30 may then turn-on the multiple Main-SUs sequentially, simultaneously, or in random order.

In some embodiments, after all the multiple Main-SUs are turned-on, the control module 30 may turn-off the Aux-SUs sequentially, simultaneously, or in random order. The control module 30 may await all the Aux-SUs are turned-off, and then turn-off the Semi-SU Q1. In some situations, even if the Semi-SU Q1 is not yet turned off when waiting for other Aux-SUs to be turned off, the targets may already enter into normal operations, as the Main-SUs associated with the targets are already turned-on, and electric currents from the battery P1 can be transmitted to these targets via the turned-on Main-SUs.

In some embodiments, the control module 30 may be configured to receive a high-voltage switch request instruction from the electrical apparatus, requesting the performing of switching operations for multiple targets (e.g., motor, and one or more electric devices, etc.). Alternatively, the control module 30 may be configured to receive multiple high-voltage switch request instructions from the electrical apparatus in a short period, each of the instructions requesting for the switching of a particular target. The control module 30 may identify these Main-SUs (e.g., K63+, K64+, etc.) that are associated with the multiple targets, and determine the specific Aux-SUs (e.g., K53, K54, etc.) corresponding to these Main-SUs. The control module 30 may first determine whether the Semi-SU Q1 is turned off, and then control the specific Aux-SUs to be turned on either one-by-one sequentially, simultaneously, or in random order. After all the Aux-SUs are turned-on, the control module 30 may then control the Semi-SU Q1 to be continuously turned on to prepare for the switching on/off of the Main-SUs.

In some embodiments, for the targets that are associated with the switch request instruction(s), some of these targets may be requesting to be switched on, while the rest of these targets may be requesting to be switched off. In this case, after the Semi-SU Q1 is turned on, the control module 30 may process these targets sequentially, simultaneously, or in random order to turn-on or turn-off each one of the Main-SUs, according to the specific switch request instruction(s) with respect to each of these targets. Thus, a single Semi-SU Q1 may be sufficient to support the performing of switch operations for multiple targets at the same time.

In some embodiments, after all the multiple Main-SUs are turned-on or turned-off according to switch request instruction(s), the control module 30 may then turn-off the associated Aux-SUs sequentially, simultaneously, or in random order. The control module 30 may await all the Aux-SUs are turned-off, and then turn-off the Semi-SU Q1. In some situations, even if the Semi-SU Q1 is not yet turned off while waiting for all the Aux-SUs to be turned off, the targets with its associated Main-SUs are turned-on may already enter into normal operations, and electric currents from the battery P1 can be transmitted to these targets via the turned-on Main-SUs. For those Main-SUs that are turned-off, the associated targets may be deemed turned off after all the corresponding Aux-SUs and the Semi-SU Q1 are turned off as well.

In some embodiments, if one of the switch request instructions is associated with the external charging apparatus, the control module 30 may perform the request instruction that is associated with the charging apparatus first, while delay or cancel these request instructions that are associated with the rest of the targets. Since when charging the battery P1, the electric current may be transmitting from the external charging apparatus to the battery P1 in a charging direction that is opposite to the discharging direction from the battery P1 to the motor or electric devices. Thus, having the charging operation being performed at the same time as the discharging operations may not be practical and may be dangerous.

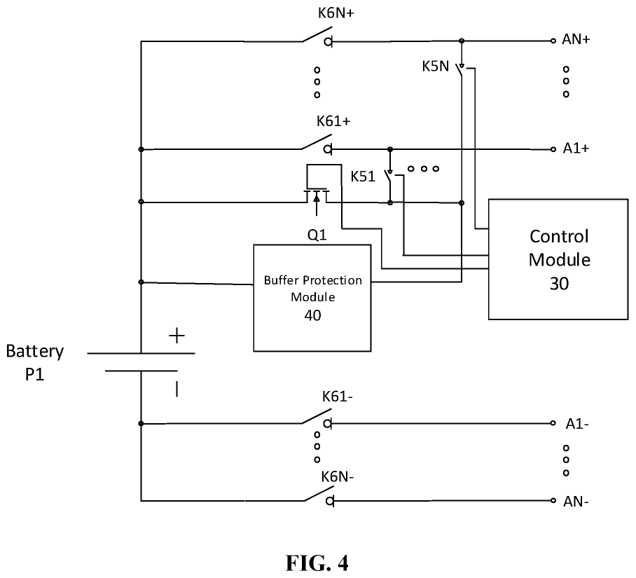

FIG. 4 is a schematic structural diagram of another battery high-voltage loop provided by embodiments of the present disclosure. As shown in FIG. 4, the safety protection circuit may further include a buffer protection module 40. The buffer protection module 40 may be connected in parallel with the Semi-SU Q1. That is, a first end of the buffer protection module 40 is connected to the first end of the Semi-SU Q1, and a second end of the buffer protection module 40 is connected to the second end of the Semi-SU Q1.

In some embodiments, the buffer protection module 40 is configured to mitigate an impact on the Semi-SU Q1 caused by a surge current, i.e., preventing the Semi-SU Q1 from being damaged due to overvoltage or overcurrent. In addition, the buffer protection module 40 may consume excess energies in the circuit of the Semi-SU Q1. Exemplarily, the buffer protection module 40 may be specifically implemented as an RCD absorption circuit, a RC buffer circuit, or a C buffer circuit and the like.

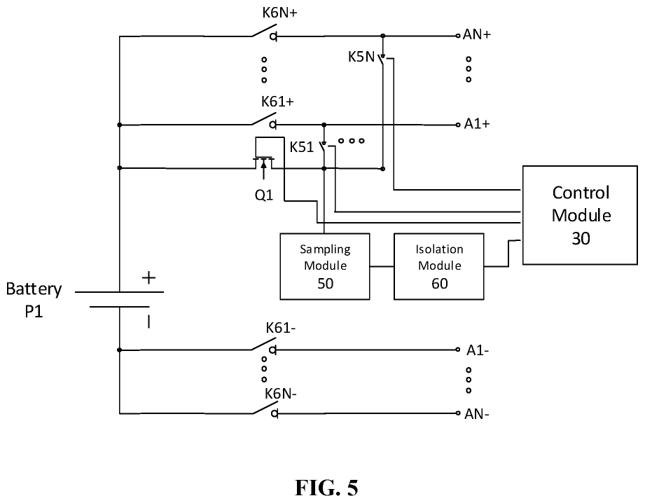

FIG. 5 is schematic structural diagram of yet another battery high-voltage loop provided by embodiments of the present disclosure. As shown in FIG. 5, the safety protection circuit may further include a sampling module 50 and an isolation module 60. The sampling module 50 is configured to collect a sample voltage from the second end of the Semi-SU Q1. The isolation module 60 is configured to realize electrical isolation between other components of the battery high-voltage loop and the control module 30.

In some embodiments, the isolation module 60 may be specifically implemented as a transformer including a primary coil and a secondary coil. Alternatively, it may be implemented as a photoelectric sensor, such as an optocoupler. Further, it may be implemented as a capacitor. It should be noted that the isolation module 60 may be implemented as any isolation modules with electrical isolation functions, which is not limited in the embodiments of the present application.

In some embodiments, the control module 30 can receive a voltage sampled by the sampling module 50 via the isolation module 60, so as to monitor the battery high-voltage loop and other components of the safety protection circuit. Specifically, when a voltage value of the sampling point is equal to a preset voltage value, it is determined that a specific target stage is completed. For example, when target stage is the pre-charging stage, if the Main-SU is arranged on the positive power transmission lines, the preset voltage value may be the positive electrode voltage of the battery P1. In another example, if the Main-SU is arranged on the negative power transmission line, the preset voltage value may be a voltage the negative electrode of the battery P1.

In this embodiment, voltages of multiple safety protection branches (i.e., a voltage of a first safety protection branch including the Aux-SU K51 and the Semi-SU Q1, . . . and a voltage of a Nth safety protection branch including the Aux-SU K5N and the Semi-SU Q1) can be monitored using one sampling module 50. Therefore, the sampling module 50 can be multiplexed, and the circuit structure can be simplified and the circuit costs can be saved.

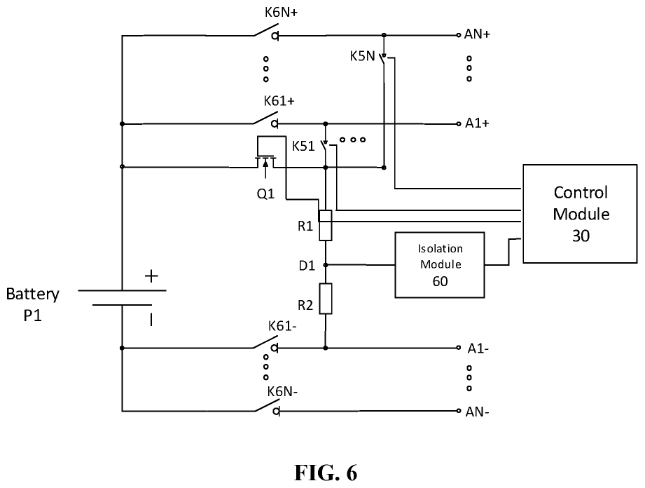

FIG. 6 is a schematic structural diagram of an exemplary battery high-voltage loop provided by embodiments of the present disclosure. As shown in FIG. 6, the sampling module 50 includes a first resistor R1 and a second resistor R2. A first end of the first resistor R1 is connected to the second end of the Semi-SU Q1, a second end of the first resistor R1 is connected to a first end of the second resistor R2, and a second end of the second resistor R2 is connected to the negative electrode of the battery P1. The second end of the resistor R1 serves as a signal sampling point D1. Exemplarily, as further shown in FIG. 6, the second end of the second resistor R2 may be connected to the negative electrode of the battery P1 through the negative main switch unit (negative Main-SU) K61−. Correspondingly, the first end of the isolation module 60 is connected to the signal sampling point D1, and the second end of the isolation module 60 is connected to the control module 30.

In some embodiments, during the pre-charging process, the control module 30 is further configured to obtain the sampled voltage value from the signal sampling point D1 via the isolation module 60. And, in the case where the sampled voltage value is equal to a voltage of the positive electrode of the battery, it is determined that the pre-charging process ends.

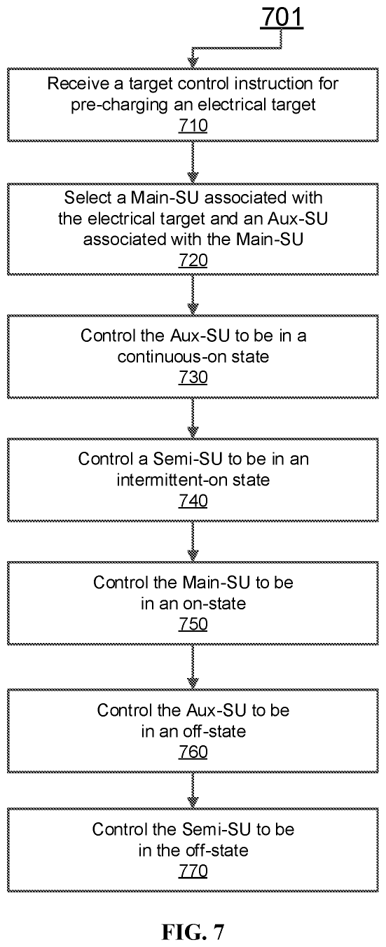

FIG. 7 is a schematic flowchart of a circuit control process provided by embodiments of the present disclosure. The process 701 sets forth various functional blocks or actions that may be described as processing steps, functional operations, events, and/or acts, which may be performed by hardware, software, and/or firmware. Those skilled in the art in light of the present disclosure will recognize that numerous alternatives to the functional blocks may be practiced in various implementations. Further, each operation in the circuit control process may be performed by the control module 30 shown in the above sections of the present disclosure.

At block 710, a control module of a safety protection circuit may receive a first target control instruction for pre-charging a first electrical target. The first electrical target may be one of the N (N>2) electrical targets supported by the safety protection circuit. At block 720, the control module may select a first Main-SU from N Main-SUs, and select a first Aux-SU from N Aux-SUs. Specifically, each of the N Main-SUs is connected to a battery and associated one of the N electrical targets, and each of the N Aux-SUs has one-to-one association/connection with one of the N Main-SUs.

At block 730, before turning on the first Main-SU, the control module may control the first Aux-SU to be in a continuous-on state. At block 740, after awaiting the first Aux-SU to be in the continuous-on state for a preset of time, the control module may control the Semi-SU to be in an intermittent-on state, to allow pre-charging of the first electrical target via the Semi-SU and the first Aux-SU.

At block 750, after the first electrical target is pre-charged, the control module may control the first Main-SU to be in an on-state. At block 760, the control module may control the first Aux-SU to be in an off-state. At block 770, the control module may then control the Semi-SU to be in the off-state. Thus, the first target control instruction may be deemed processed by the control module.

In some embodiments, at block 710, the control module may receive a second target control instruction for pre-charging a second electrical target. The second electrical target may be another one of the N electrical targets supported by the safety protection circuit. In this case, the control module may simultaneously process the first target control instruction and the second target control instruction. Alternatively, the first target control instruction may request the pre-charging of the first electrical target and the second electrical target.

At block 720, the control module may select a second Main-SU from the N Main-SUs, and select a second Aux-SU from the N Aux-SUs. At block 730, before turning on the second Main-SU, the control module may control the second Aux-SU to be in a continuous-on state. At block 740, after awaiting both the first Aux-SU and the second Aux-SU to be in the continuous-on state for a preset of time, the control module may control the Semi-SU to be in the intermittent-on state, to allow pre-charging of the first electrical target via the Semi-SU and the first Aux-SU, and pre-charging of the second electrical target via the Semi0SU and the second Aux-SU, both pre-charging being performed sequentially or simultaneously.

At block 750, after the first electrical target and the second electrical target are pre-charged, the control module may control the first Main-SU to be in the on-state and control the second Main-SU to be in the on-state. At block 760, the control module may control the first Aux-SU to be in the off-state, and control the second Aux-SU to be in the off-state. At block 770, the control module may await the first Aux-SU and the second Aux-SU to be in the off-state, and then control the Semi-SU to be in the off-state. Thus, the second target control instruction may be deemed processed by the control module.

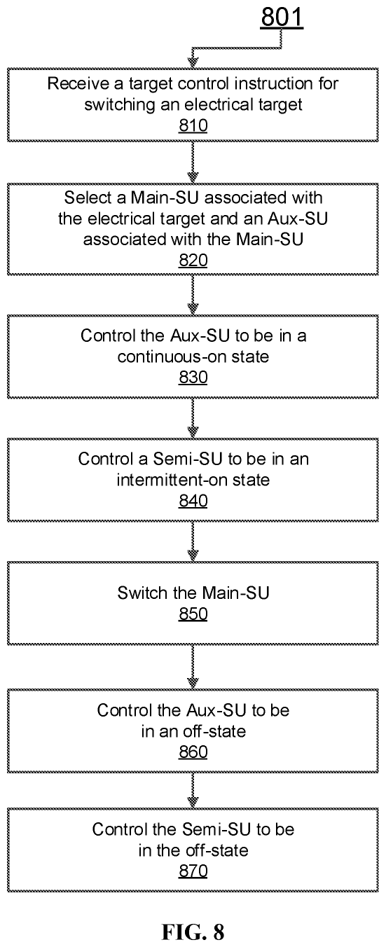

FIG. 8 is a schematic flowchart of a circuit control process provided by embodiments of the present disclosure. The process 801 sets forth various functional blocks or actions that may be described as processing steps, functional operations, events, and/or acts, which may be performed by hardware, software, and/or firmware. Those skilled in the art in light of the present disclosure will recognize that numerous alternatives to the functional blocks may be practiced in various implementations. Further, each operation in the circuit control process may be performed by the control module 30 shown in the above sections of the present disclosure.

At block 810, a control module of a safety protection circuit may receive a first target control instruction for switching a first electrical target. The first electrical target may be one of the N electrical targets supported by the safety protection circuit. At block 820, the control module may select (e.g., determine or identify) a first Main-SU from N Main-SUs, and select a first Aux-SU from N Aux-SUs. Specifically, each of the N Main-SUs is connected to a battery and associated one of the N electrical targets, and each of the N Aux-SUs has one-to-one association/connection with one of the N Main-SUs.

At block 830, before switching the first Main-SU to on-state or off-state, the control module may control the first Aux-SU to be in a continuous-on state. At block 840, after awaiting the first Aux-SU to be in the continuous-on state for a preset of time, the control module may control the Semi-SU to be in the continuous-on state.

At block 850, after the first Aux-SU and the Semi-SU are in the continuous-on state, the control module may switch the first Main-SU from on to off, or from off to on, based on the first target control instruction. At block 860, after the first Main-SU is switched, the control module may control the first Aux-SU to be in an off-state and then control the Semi-SU to be in the off-state. Thus, the first target control instruction may be deemed processed by the control module.

In some embodiments, at block 810, the control module may receive a second target control instruction for switching a second electrical target. The second electrical target may be another one of the N electrical targets supported by the safety protection circuit. In this case, the control module may simultaneously process the first target control instruction and the second target control instruction. Alternatively, the first target control instruction may request the switching of the first electrical target and the second electrical target.

At block 820, the control module may select a second Main-SU from the N Main-SUs, and select a second Aux-SU from the N Aux-SUs. At block 830, before turning on the second Main-SU, the control module may control the second Aux-SU to be in a continuous-on state. At block 840, after awaiting both the first Aux-SU and the second Aux-SU to be in the continuous-on state for a preset of time, the control module may control the Semi-SU to be in the continuous-on state.

At block 850, the control module may switch the first Main-SU and switch the second Main-SU, either sequentially or simultaneously. At block 860, the control module may control the first Aux-SU to be in the off-state, and control the second Aux-SU to be in the off-state. The control module may await the first Aux-SU and the second Aux-SU to be in the off-state, and then control the Semi-SU to be in the off-state. Thus, the second target control instruction may be deemed processed by the control module.

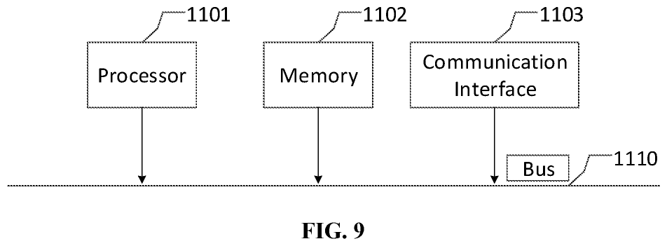

FIG. 9 illustrates a schematic structural diagram of hardware of a circuit control device, provided by embodiments of the present disclosure. The circuit control device may include a processor 1101 and a memory 1102 having computer program instructions stored thereon. Particularly, the aforementioned processor 1101 may include a Central Processing Unit (CPU), an Application Specific Integrated Circuit (ASIC), or one or more integrated circuits that may be configured to implement of the embodiments of the present application.

The memory 1102 may include a mass memory for data or instructions. For example, but not limitation, the memory 1102 may include a Hard Disk Drive (HDD), a floppy disk drive, a flash memory, an optical disk, a magneto-optical disk, a magnetic tape or a Universal Serial Bus (USB) drive, or a combination of two or more of them. In some examples, the memory 1102 may include removable or non-removable (or fixed) media, or the memory 1102 may be a non-volatile solid-state memory. In some embodiments, the memory 1102 may be internal or external to the circuit control device.

In some examples, the memory 1102 may be a Read Only Memory (ROM). In an example, the ROM may be a mask-programmed ROM, a programmable ROM (PROM), an erasable PROM (EPROM), an electrically erasable PROM (EEPROM), an electrically rewritable ROM (EAROM) or flash memory, or a combination of two or more of them.

The memory 1102 may include a read-only memory (ROM), a random-access memory (RAM), a magnetic disk storage media device, an optical storage media device, a flash memory device, an electrical, optical, or other physical/tangible memory storage device. Therefore, generally, the memory may include one or more tangible (non-transitory) computer-readable storage media (e.g., memory devices) encoded with software including computer-executable instructions, and when the software is executed (e.g., by one or more processors), it is operable to perform operations described with reference to the method according to an aspect of the present disclosure.

The processor 1101 reads and executes the computer program instructions stored in the memory 1102, to implement the methods in the embodiments shown in FIG. 7 to FIG. 10, and achieve corresponding technical effects achieved when the methods/steps of the embodiments shown in FIG. 7 to FIG. 10 are executed, which will not be repeated here, for concision of the description.

In an example, the circuit control device may further include a communication interface 1103 and a bus 1110. As shown in FIG. 9, the processor 1101, the memory 1102, and the communication interface 1103 are connected and communicate mutually through the bus 1110. The communication interface 1103 is mainly used to implement communications between various modules, apparatuses, units and/or devices in the embodiments of the present application.

The bus 1110 may include hardware, software, or both, and couple components of an online data flow accounting device to each other. For example but not limitation, the bus may include an Accelerated Graphics Port (AGP) or other graphics bus, an Extended Industry Standard Architecture (EISA) bus, a Front Side Bus (FSB), a Hyper Transport (HT) interconnection, an Industry Standard Architecture (ISA) bus, an unlimited bandwidth interconnection, a low pin count (LPC) bus, a memory bus, a microchannel architecture (MCA) bus, a peripheral component interconnection PCI bus, a PCI-Express (PCI-X) bus, a Serial Advanced Technology Attachment (SATA) bus, a Video Electronics Standards Association Local (VLB) bus or other suitable bus or a combination of two or more of them. Where appropriate, the bus 1110 may include one or more buses. Although the embodiments of the present application describe and show specific buses, the present disclosure has contemplated any suitable bused or interconnections.

The circuit control device can execute the circuit control methods in the embodiments of the present application, so as to realize the circuit control methods and devices described in conjunction with FIG. 2 to FIG. 8.

In addition, in combination with the circuit control methods of the foregoing embodiments, embodiments of the present application may provide a non-transitory computer storage medium to implement the methods. The computer storage medium has computer program instructions stored thereon. When the computer program instructions are executed by the processor, any of the circuit control methods of the foregoing embodiments can be implemented by the processor.

It should be clarified that the present application is not limited to the specific configurations and process described above and shown in the drawings. For the sake of brevity, a detailed description of known methods is omitted here. In the above embodiments, several specific steps are described and shown as examples. However, the method processes of the present application are not limited to the specific steps described and shown, and those skilled in the art can make various changes, modifications and additions, or change the order between the steps after understanding the spirit of the present application.

It should be noted that functional blocks shown in the above-mentioned structural block diagrams may be implemented as hardware, software, firmware, or a combination thereof. When implemented in hardware, they can be, for example, electronic circuits, application specific integrated circuits (ASICs), appropriate firmware, plug-ins, function cards, and so on. When implemented in software, elements of the present application are programs or code segments used to perform required tasks. The programs or code segments may be stored in machine-readable media, or transmitted on transmission media or communication links through data signals carried in carrier waves. “Machine-readable media” may include any media that can store or transmit information. Examples of machine-readable media may include electronic circuits, semiconductor memory devices, ROMs, flash memories, erasable ROMs (EROMs), floppy disks, CD-ROMs, optical disks, hard disks, fiber optic media, Radio Frequency (RF) links, and so on. The code segments can be downloaded via a computer network such as the Internet, an intranet, etc.

Various aspects of the present disclosure are described with reference to the flowcharts and/or block diagrams of the methods, apparatuses, devices, and computer program products according to the embodiments of the present disclosure. It should be understood that each block in the flowcharts and/or block diagrams and combinations of blocks in the flowcharts and/or block diagrams can be implemented by computer program instructions. These computer program instructions can be provided to a processor of a general-purpose computer, a special-purpose computer, or other programmable data processing apparatus, to produce a machine that causes these instructions executed by the processor of the computer or other programmable data processing apparatus to enable the implementation of the functions/actions specified in one or more blocks of the flowcharts and/or block diagrams. Such processor may be, but is not limited to, a general-purpose processor, a dedicated processor, a special application processor, or a field programmable logic circuit. It can also be understood that each block in the block diagrams and/or flowcharts and a combination of the blocks in the block diagrams and/or flowcharts may be implemented by dedicated hardware that performs specified functions or actions, or may be implemented by a combination of the dedicated hardware and the computer instructions.

The above embodiments are only specific implementations of the present application. Those skilled in the art can clearly understand that, for convenience and conciseness of the description, specific working processes of the above-described systems, modules and units may refer to corresponding processes in the foregoing method embodiments, which will not be repeated here. It should be understood that the protection scope of the present application is not limited to this. Any person skilled in the art can easily conceive of equivalent changes or substitutions within the technical scope disclosed in the present application, which should be covered within the protection scope of the present application.

Although the present application has been described with reference to preferred embodiments, various modifications may be made thereto and components thereof may be replaced with equivalents without departing from the scope of the present application. Especially, as long as there is no structural conflict, various technical features mentioned in various embodiments can be combined together in any manner. The present application is not limited to the specific embodiments disclosed herein, instead, it can include all technical solutions that fall within the scope of the claims.

What is claimed is:

1. A safety protection circuit, comprising:
N (N>2) main switch units (Main-SUs) for connecting to N electrical targets, wherein each Main-SU selected from the N Main-SUs is connected to a battery and is associated with one of the N electrical targets;
a semiconductor switch unit (Semi-SU) connected to the battery;
N auxiliary switch units (Aux-SUs) having one-to-one associations with the N Main-SUs, wherein for each Aux-SU selected from the N Aux-SUs and associated with a corresponding Main-SU, the Aux-SU is connected to the Semi-SU and the corresponding Main-SU; and
a control module coupled with the Semi-SU and the N Aux-SUs, wherein the control module is configured to
receive a target control instruction,
when the target control instruction is to pre-charge a first set of electrical targets among the N electrical targets,
select a first set of Main-SUs from the N Main-SUs that are associated with the first set of electrical targets, and select a first set of Aux-SUs from the N Aux-SUs that are associated with the first set of Main-SUs,
control each of the first set of Aux-SUs to be in a continuous-on state,
control the Semi-SU to be in an intermittent-on state to allow pre-charging of the electrical targets via the Semi-SU and the first set of Aux-SUs,
after the first set of electrical targets are pre-charged, control the first set of Main-SUs to be in a turn-on state, and
control the first set of Aux-SUs to be in a turn-off state and then control the Semi-SU to be in a turn off state.

2. The safety protection circuit of claim 1, wherein in the intermittent-on state, the Semi-SU is intermittently turned on by repeatedly being in alternating on-state for a period of time and off-state for another period of time.

3. The safety protection circuit of claim 2, wherein the Semi-SU is intermittently turned on based on a pre-charging rate, and the pre-charging rate is adjustable in accordance with a duty ratio in the target control instruction.

4. The safety protection circuit of claim 1, further comprises:
a buffer protection module connected in parallel with the Semi-SU, wherein the buffer protection module is configured to mitigate an impact on the Semi-SU caused by a surge current.

5. The safety protection circuit of claim 1, further comprises:
a sampling module configured to collect a sample voltage from sampling point in between the Semi-SU and the first set of Aux-SUs, wherein the control module is configured to determine whether the pre-charging of the first electrical target is completed by comparing the sample voltage with a preset voltage value.

6. The safety protection circuit of claim 5, further comprises:
an isolation module coupled with the sampling module, wherein the isolation module is configured to collect the sample voltage from the sampling module.

7. The safety protection circuit of claim 1, wherein:
The N Main-SUs are arranged on positive or negative power transmission lines connecting to the battery.

8. The safety protection circuit of claim 1, wherein when the target control instruction is to switch a second set of electrical targets among the N electrical targets, the control module is further configured to
select a second set of Main-SUs from the N Main-SUs that are associated with the second set of electrical targets, and select a second set of Aux-SUs from the N Aux-SUs that are associated with the second set of Main-SUs,
upon a determination that the Semi-SU is not turned on, control the second set of Aux-SUs to be in a continuous-on state,
control the Semi-SU to be in the continuous-on state,
control the second set of Main-SUs to switch, and
after the second set of electrical targets are switched, control the second set of Aux-SUs to be in a turn-off state and then control the Semi-SU to be in a turn off state.

9. The safety protection circuit of claim 8, wherein the controlling the second set of Main-SUs to switch includes controlling each of the second set of Main-Sus to switch from its previous on or off state to the other state.

10. The safety protection circuit of claim 8, wherein when one of the second set of electrical targets is a charging apparatus, the controlling of the second set of Aux-SUs to be in the continuous-on state comprising:
controlling the Aux-SU among the second set of Aux-Sus which is associated with the charging apparatus to be in the continuous-on state;
controlling rest of the second set of Aux-SUs to be in the off state until the charging apparatus completes charging the battery; and
controlling, once the Aux-SU associated with the charging apparatus is in the off state, the rest of the second set of Aux-SUs to be in the continuous-on state.

11. The safety protection circuit of claim 10, wherein
the N electrical targets include a motor, a charging apparatus, and one or more high-voltage electronic devices.

12. The safety protection circuit of claim 1, wherein
The set of electrical targets comprises one or more electrical targets.

13. A safety protection circuit, comprising:
N (N>2) main switch units (Main-SUs) for connecting to N electrical targets, wherein for each Main-SU among the N Main-SUs, a first end of the Main-SU is connected to an electrode of a battery, and a second end of the Main-SU is connected to an associated one of the N electrical targets;
a semiconductor switch unit (Semi-SU) having its first end connected to the electrode of the battery;
N auxiliary switch units (Aux-SUs) having one-to-one associations with the N Main-SUs, wherein for each Aux-SU among the N Aux-SUs and associated with a corresponding Main-SU, a first end of the Aux-SU is connected to a second end of the Semi-SU, and a second end of the Aux-SU is connected to the second end of the corresponding Main-SU; and
a control module coupled with the Semi-SU and the N Aux-SUs, wherein the control module is configured to
receive a target control instruction,
when the target control instruction is to pre-charge a first electrical target selected from the N electrical targets,
before turning on a first Main-SU, control a first Aux-SU to be in a continuous-on state, wherein the first Main-SU among the N Main-SUs is associated with the first electrical target and the first Aux-SU among the N Aux-SUs is associated with the first Main-SU,
control the Semi-SU to be in an intermittent-on state to allow pre-charging of the first electrical target,
after the first electrical target is pre-charged, control the first Main-SU to be in a turn on state, and
control the first Aux-SU to be in a turn off state and then control the Semi-SU to be in a turn off state.

14. A control method, performed by a control module, comprising:
receiving a target control instruction, when the target control instruction is to pre-charge a first set of electrical targets selected from N (N>2) electrical targets;
selecting a first set of main switch units (Main-SUs) from N Main-SUs, wherein each of the N Main-SUs is connected to a battery and an associated one of the N electrical targets;
selecting a first set of auxiliary switch units (Aux-SUs) from N Aux-SUs, wherein each of the N Aux-SUs has one-to-one connection with one of the N Main-SUs;
before turning on the first set of Main-SUs, controlling the first set of Aux-SUs to be in a continuous-on state;
controlling a semiconductor switch unit (Semi-SU) to be in an intermittent-on state to allow pre-charging of the first set of electrical targets via the Semi-SU and the first set of Aux-SUs, wherein the Semi-SU is connected with the battery and each of the N Aux-SUs;
after the first set of electrical targets are pre-charged, controlling the first set of Main-SUs to be in an on-state; and
controlling the first set of Aux-SUs to be in an off-state and then controlling the Semi-SU to be in the off-state.

15. The method of claim 14, wherein the controlling of the Semi-SU to be in the intermittent-on state further comprising:
awaiting the first set of Aux-SUs being in the continuous-on state for a preset of time before controlling the Semi-SU to be in the intermittent-on state.

16. The method of claim 14, wherein the controlling of the Semi-SU to be in the intermittent-on state further comprising:
awaiting the first set of Aux-SUs to be in the continuous-on state before controlling the Semi-SU to be in the intermittent-on state.

17. The method of claim 14, wherein the controlling of the Semi-SU to be in the off-state further comprising:
awaiting the first set of Aux-SUs to be in the off-state before controlling the Semi-SU to be in the off-state.

18. The method of claim 14, when the target control instruction is to switch a second set of electrical targets among the N electrical targets, the method further comprising:
selecting a second set of Main-SUs from the N Main-SUs that are associated with the second set of electrical targets;
selecting a second Aux-SU from the N Aux-SUs that are associated with the second set of Main-SUs;
before switching the first set of Main-SUs, controlling each of the second set of Aux-SUs to be in a continuous-on state;
controlling the Semi-SU to be in the continuous-on state;
controlling to switch each of the second set of Main-SUs;
after the second set of electrical targets are switched, controlling the second set of Aux-SUs to be in the off-state; and
controlling the Semi-SU to be in the off-state.
